(19) United States
(12) Patent Application Publication
(10) Pub. No.: US 2003/0050861 A1
(43) Pub. Date: Mar. 13, 2003

(54) System and method for running a dynamic auction

(75) Inventors: Joshua J.D. Martin, Arlington, VA (US); Todd H. Walker, Arlington, VA (US)

Correspondence Address: William T. Ellis, FOLEY & LARDNER, Washington Harbour, 3000 K Street, N.W., Suite 500, Washington, DC, 20007-5109, US

(73) Assignee: G.E. INFORMATION SERVICES, INC.

(21) Appl. No.: 09/948,902

(22) Filed: Sep. 10, 2001

(51) Int. Cl. G06F 17/60

(52) U.S. Cl. 705/27

(57) ABSTRACT

A system and method for conducting a forward auction and a reverse auction from a single software component operable on a computer system receives information regarding the details of the auction and the direction of the auction, where the direction is either forward or reverse. A first auction is run based on the received information with the single software component. After receiving at least one bid, a winner of the first auction is determined from the at least one bid. A second auction is run with the single software component in the other of the forward or reverse direction based on the received information and information related to the determined winning bid.

### FIELD OF THE INVENTION

The present invention relates generally to running forward and reverse auctions, and more particularly to using a common engine and data store to run forward and reverse auctions.

### BACKGROUND OF THE INVENTION

To maximize profits, retailers, manufacturers and other suppliers search for the best price when buying or selling products, materials or services. To minimize prices when buying or maximize prices when selling, these parties may request multiple participants to submit bids for the product being bought or sold. For example, a retailer for a product may request bids from several different suppliers of the product to find the supplier willing to provide the product for the lowest cost. Similarly, a supplier for a product may solicit bids from multiple retailers to find the retailer willing to purchase the supplier's product at the best price.

To facilitate these bidding processes, the party looking to buy or sell a product may use a forward auction or a reverse auction. The party soliciting bids may be referred to as the sponsor of the auction. In the forward auction, the sponsor is typically requesting bids from one or more participants for a product or service being sold by the sponsor. Accordingly, in the forward auction, the sponsor is usually seeking the highest bid. In the reverse auction, the sponsor is typically requesting bids from one or more participants for a common product or service being sold by the participants. In contrast to the forward auction, the sponsor is usually seeking the lowest bid in the reverse auction.

In either the forward auction or the reverse auction, the sponsor provides information about the auction including, for example, the product of interest, details regarding how much of the product is needed or available for sale and when, as well as any other relevant information. The sponsor may also include details as to how the auction process is run, such as whether or not the participants are allowed to see the bids of other participants during the auction and the criteria for winning the auction. The description and details of the auction may be referred to collectively as the event. The sponsor may also designate who is invited to participate in the process. The invited participants each review the event and submit bids in response. At this point, the sponsor of the auction may elect to award the winning bid, reject it and close the process, or host another auction.

The auction process, whether it be forward or reverse, may be automated using one or more computers interconnected within a local network or via the Internet. For example, a server computer may include programming structure enabling it either to run the forward auction engine or to run the reverse auction engine. The sponsor of the event for the process running on the server could log on or connect to the server to post the event, and participants could then log on or connect to the server to review the event and post their bids. Subsequently, the sponsor can evaluate the bids and take an action based on the evaluation.

The forward auction and the reverse auction may also be used in combination. For example, the sponsor of the event may use the reverse auction to purchase a certain amount of product from a group of manufacturers and then use the forward auction to sell the amount of product purchased in the reverse auction to get the highest price.

Current processes accommodating data transfer between forward and reverse auction engines are manual, segmented and time-intensive. For example, once a reverse auction is complete, a user must manually transfer data if the recently purchased goods are to be immediately sold in a forward auction. Similarly, the segmentation is evident in multiple steps, inherently costing time and resources. Further, the required data re-entry results in an interruption of vertical flow in the supply chain.

### SUMMARY OF THE INVENTION

Briefly, a method for conducting a forward auction and a reverse auction from a single software component operable on a computer system receives information regarding the details of the auction and the direction of the auction, where the direction is either forward or reverse. A first auction is run based on the received information with the single software component. After receiving at least one bid, a winner of the first auction is determined from the at least one bid. A second auction is run with the single software component in the other of the forward or reverse direction based on the received information and information related to the determined winning bid.

In another aspect of the invention, the single software component is a self-contained re-deployable piece of software code and comprises pre-developed pieces of application code assembled into a single working application system.

### BRIEF DESCRIPTION OF THE DRAWINGS

FIG. 1 is a block diagram of a system 100 consistent with the present invention for transitioning between a forward auction and a reverse auction.

FIG. 2 is a flow diagram of a process for using forward and reverse auction processes consistent with the present invention.

FIGS. 3A-3C are examples of screen shots of displays from the process of FIG. 2.

FIG. 4 is a flow diagram of an event creation process consistent with the present invention.

FIG. 5 is a flow diagram for creating a bid on the market maker 120 consistent with the present invention.

FIG. 6 is a flow diagram of a simultaneous forward and reverse auction process consistent with the present invention.

### DETAILED DESCRIPTION OF THE PREFERRED EMBODIMENT

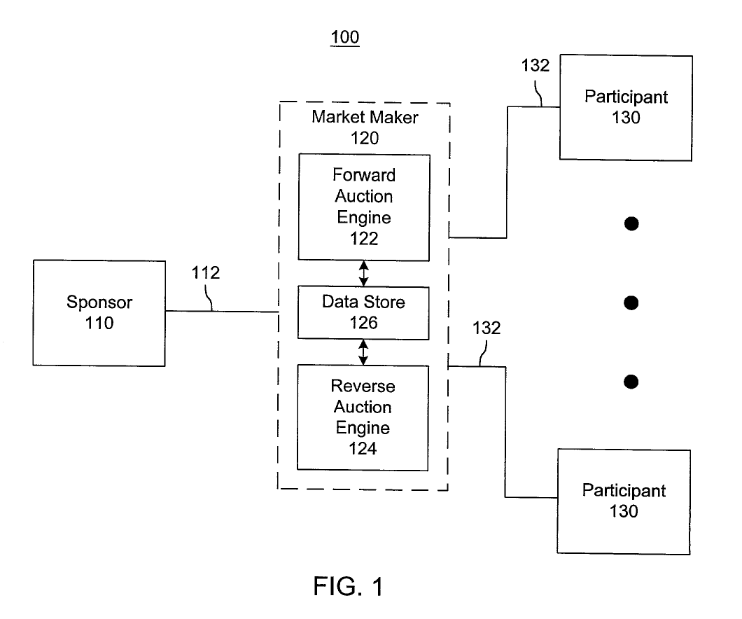

FIG. 1 is a block diagram of a system 100 consistent with the present invention for transitioning between a forward auction and a reverse auction. As shown in FIG. 1, system 100 include a sponsor 110, a market maker 120, and a plurality of participants 130. The sponsor 110 may be implemented, for example, as a personal computer or any other type of processing system capable of transmitting and receiving information over a network. The sponsor 110 also includes a device for entering information, such as a keyboard and a mouse, and a device for viewing information, such as a monitor.

The sponsor 110 is connected to the market maker 120 via a connection 112. The connection 112 from the sponsor 110 to the market maker 120 may be implemented as a network connection, such as an Ethernet connection or a TCP/IP connection over the Internet, which allows information to be communicated to and from the market maker 120.

The market maker 120 operates both a forward auction engine 122 and a reverse auction engine 124, which will be described in more detail below. The market maker 120 also includes a data store 126, which is connected to both the forward auction engine 122 and the reverse auction engine 124. In one aspect of the present invention, the market maker 120 may be implemented on a server computer comprising programming structure for operating the forward auction engine 122 and the reverse auction engine 124. The server computer may include a storage device, such as a hard disk drive, to maintain the information in the data store 126. The market maker 120 is preferably implemented in a network environment to allow the market maker 120 to communicate with other computers.

The forward auction engine 122, the reverse auction engine 124 and the data store 126 may be implemented across one or more computers collectively constituting the market maker 120. As shown in FIG. 1, the market maker 120 includes the connection 112 to the sponsor 110, as well as a plurality of connections 132 to the participants 130. When implemented as a server computer, the market maker 120 may be accessible to other computers via the connections 112 and 132 through a local area network or the Internet. For example, the server computer may host a web site for the market maker 120, which allows the sponsor 110 and the participants 130 to access the market maker 120 via the Internet with a browser.

In a preferred embodiment, the forward auction engine 122 and the reverse auction engine 124 are implemented on the same server computer. It is also possible, however, to implement the forward auction engine 122 and the reverse auction engine 124 on separate and independent computers. When implemented on separate computers, the forward auction engine 122 and the reverse auction engine 124 may be connected by a network connection to the data store 126, which may be implemented on one of the same computers as the forward auction engine 122 and the reverse auction engine 124 or on another computer separate from both. The network connection may be, for example, an Ethernet connection or a TCP/IP connection over the Internet, to allow information to be communicated between the forward auction engine 122, the reverse auction engine 124 and the data store 126.

The participants 130 may be implemented in a manner similar or identical to the sponsor 110. In particular, the participants 130 may be implemented as a personal computer or other type of processing system capable of transmitting and receiving information over a network. The participants 130 each include a device for entering information, such as a keyboard and a mouse, and a device for viewing information, such as a monitor. The participants 130 are connected to the market maker 120 via the connections 132. Like the connection 112, the connections 132 from the participants 130 to the market maker 120 may be implemented as a network connection, such as an Ethernet connection or a TCP/IP connection over the Internet, which allows information to be communicated between the participants 130 and the market maker 120.

When the forward auction engine 122 and the reverse auction engine 124, as well as the data store 126, are implemented on the same server computer, it is possible for the sponsor 110 and the participants 130 to log on to a single server to use either the forward auction engine 122 and the reverse auction engine 124. The step of logging on to this server is preferably done through a secure connection process. For example, after registering as users on the server for the forward auction engine 122 and the reverse auction engine 124, the sponsor 110 and the participants 130 would be prompted to use a unique username and password to log on to the server, thereby ensuring that only registered users are capable of accessing the forward auction engine 122 and the reverse auction engine 124. In addition, all information transferred between the sponsor 110 and the server may be encrypted to ensure the security of the information.

The forward auction engine 122 and the reverse auction engine 124 may be implemented with a single software component. A component is a self-contained re-deployable piece of software code, which is generic enough to provide functionality for multiple processes. The component comprises pre-developed pieces of application code that can be assembled into working application systems. The single software component is also adaptable and changeable to accommodate new and additional processes.

In one aspect of the present invention, the core programming structure of the component relates to the generic features of an auction, irrespective of the direction of the auction. This core programming structure may be referred to as the auction object. The generic features of the auction included in the auction object may include the name of the auction and the start/end time of the auction.

Other details of the auction may be considered dynamic features of the auction. These dynamic features may be referred to as auction-parameter objects. The auction-parameter objects identify information about the auction, such as, the items being bought or sold, the participants, the direction of the auction (reverse or forward), the type of auction, awarding criteria and any other detail that may be used in an auction. This information is stored in the data store 126 and referred to by the auction-parameter objects. The auction-parameter objects also provide functionality used to run an auction. For example, one auction-parameter object may provide functionality for a forward auction, and another auction-parameter object may provide functionality for a reverse auction.

Based on the information provided by the sponsor 110, the auction object will point to the auction-parameter objects that are to be used to run the auction. For example, if the sponsor 110 elects to run a reverse auction, the auction object will point to the auction-parameter object corresponding to the reverse auction.

By implementing the forward auction engine 122 and the reverse auction engine 124 with the single software component, the market maker 120 can run both forward and reverse auctions from a single piece of software code and refer to a single data source, the data store 126, to supply the information for running both types of auctions. In addition, the single software component can be expanded to cover different types of auctions or use additional information by incorporating new auction-parameter objects having new functionality into the single software component. To use the new functionality, the auction object is merely altered to point to the new auction-parameter object. The single software component may be implemented using Java, although other object-oriented or structured languages may be used.

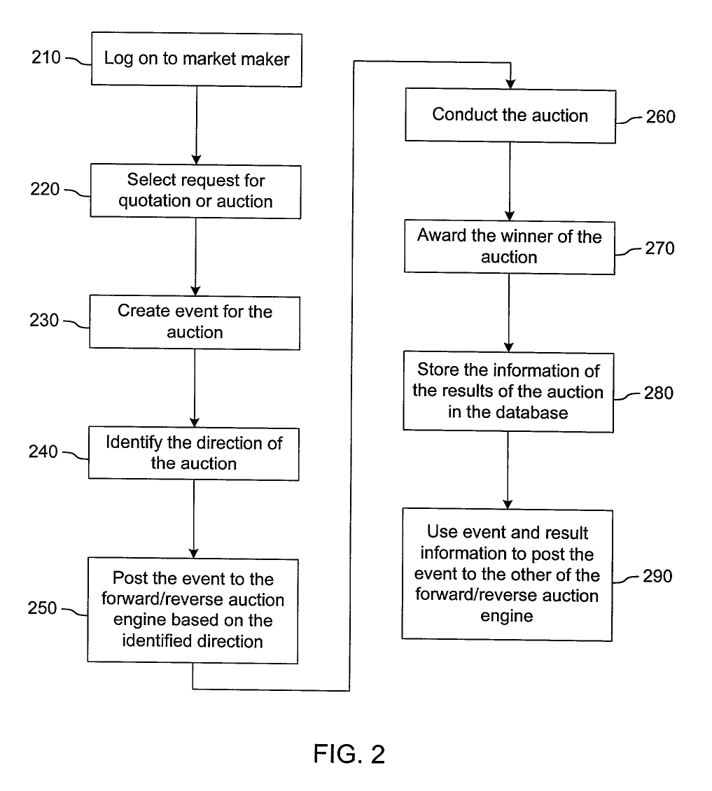

FIG. 2 is a flow diagram of a process for using forward and reverse auction processes consistent with the present invention. As shown in FIG. 2, the sponsor 110 first logs on to the market maker 120 (step 210). The manner in which the sponsor 110 logs on to the market maker 120 depends upon the configuration of the sponsor 110 and the market maker 120. For example, if the market maker 120 is implemented on a server accessible by the Internet, then the sponsor 110 may log on to the market maker 120 by accessing the market maker 120 through a web page. Alternatively, if the market maker 120 and the sponsor 110 are implemented in the same LAN, then the sponsor 110 may log on to the market maker simply by logging on to the LAN itself.

In either case, the sponsor 110 may be prompted to provide a username and password to access the market maker 120 before being given access. If the sponsor 110 has not previously registered with the market maker 120, the sponsor 110 may be prompted to do so. To register with the market maker 120, the sponsor may provide identification and contact information, such as name, address, telephone number and e-mail address, as well as billing information, such as a credit card number.

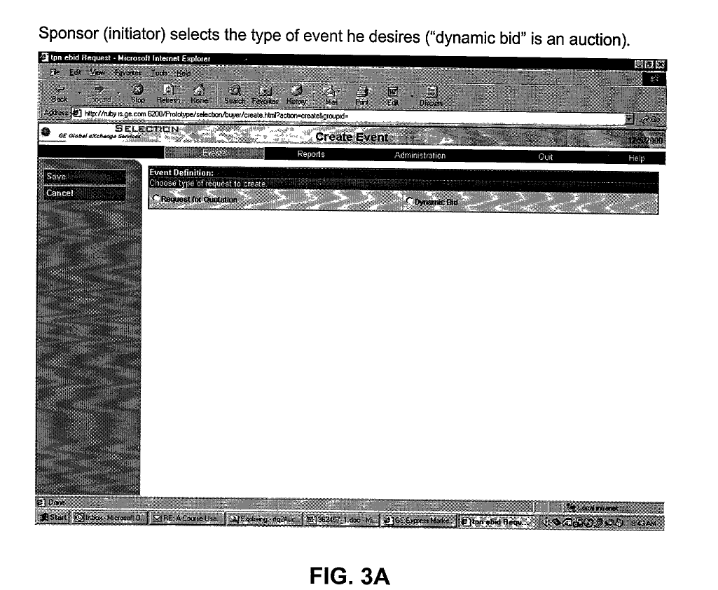

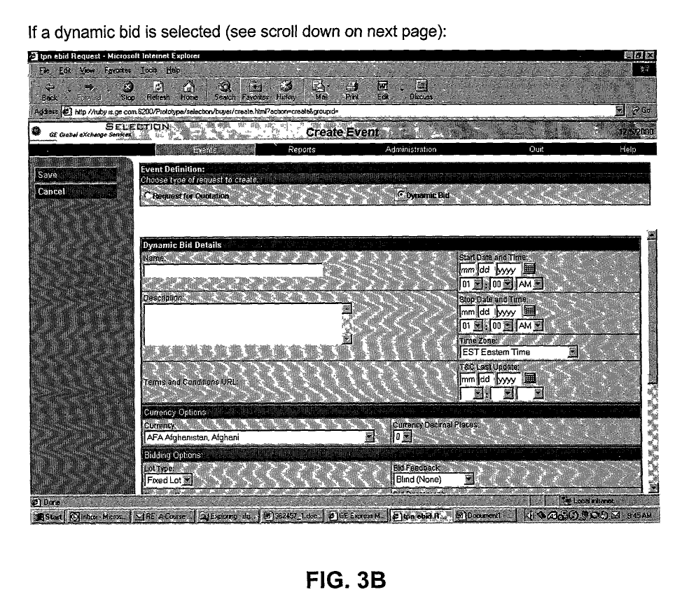

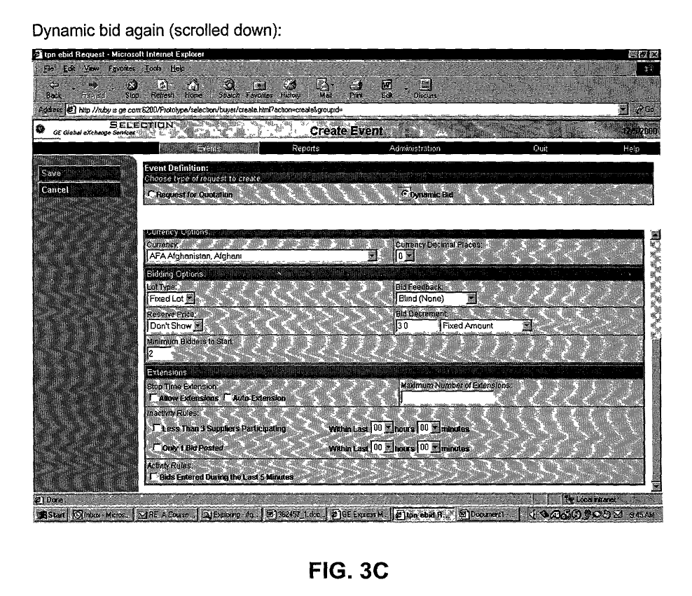

After logging on to the market maker 120, the sponsor 110 selects the type of request to create (step 220). The request may be to have a request for quotation (RFQ) or to conduct an auction. The sponsor 110 may effect the selection with a mouse click or with a keyboard entry. FIG. 3A shows a screen shot of a web page or a display from an application for effecting the selection of the request to create. As shown in FIG. 3A, the sponsor 110 may select an RFQ or a dynamic bid. The dynamic bid is equivalent to an auction. The sponsor selects either the RFQ or the dynamic bid by placing the mouse cursor over one of the options and clicking on that option.

In response to the selection of the request to create an auction, the sponsor 110 is prompted to create an event for the auction (step 230). An event includes all of the details regarding a product that the sponsor 110 is seeking to purchase or to sell. These details include, for example, the name of the auction, the start and end time of the auction, the name of the product, a description of it, a target price, the amount to be purchased or sold, the timing for a contract and delivery of the product, and any other information that may be useful to the participant 140 when submitting a bid. In addition, the event may include attachments, such as figures, drawings, pictures or text, which help to describe the product more completely. The event may also include a list of participants 130 from which the sponsor 110 wishes to solicit bids. The list of participants 130 may be considered part of or separate to the creation of the event.

FIGS. 3B and 3C show a screen shot of a web page or a display of an application for providing the details of the event to be posted for the auction (or dynamic bid). As shown in FIG. 3B, the details of the auction include a name, a description, the start and stop time, the terms and conditions, and the currency type. As shown in FIG. 3C, the details of the auction further include several bidding options, such as the lot type, the reserve price, the minimum number of bidders for starting the auction, the type of bid feedback and the amount of bid increments or decrements. In addition, FIG. 3C shows that the details of the auction may include extensions, as well as activity and inactivity rules.

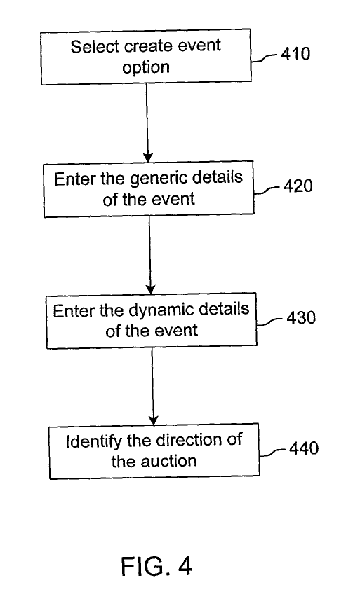

FIG. 4 is a flow diagram of an event creation process consistent with the present invention. As shown in FIG. 4, the sponsor 110 first selects a create event option (410). The selection of the option to create an event may be effected with a click of a pointing device or with a keyboard entry. Alternatively, as described above, the sponsor 110 may be prompted to create an event in response to selecting the creation of an auction.

After selecting to create an event, the sponsor 110 is prompted to enter the generic details of the event (step 420). As described above, the forward auction engine 122 and the reverse auction engine 124 may be implemented from a single software component. With this implementation, the market maker 120 can run forward and reverse auctions using the same piece of code. To facilitate this implementation, the sponsor 110 first provides generic details of the event, which are details that are common to both forward and reverse auctions. The generic details include, for example, the name of the auction and the start and end time of the auction. The generic details form the auction object, as described above. The information for the auction object is stored in the data store 126.

The sponsor 10 is then prompted to enter the dynamic details of the event (step 430). The dynamic details include, for example, the description of the product being sold or bought, the currency type, the lot type, extensions, bid feedback. Each dynamic detail corresponds to a different auction-parameter object. For each auction-parameter object for which information is provided, a reference is made between the auction object and the auction-parameter object. The reference may be a pointer to the auction-parameter object and its associated information stored in the data store 126.

Finally, the sponsor 110 identifies the direction of the auction (step 440). Like the dynamic details, there is an auction-parameter object corresponding to the identified direction, one for a forward auction and one for a reverse auction. Having auction-parameter objects for both forward and reverse auctions allows the sponsor 110 to run either a forward or reverse auction, or as described below, both a forward and reverse auction at the same time, while using a single software component. The sum of the auction object and each of the auction-parameter objects to which the auction object points constitute the event.

Returning to FIG. 2, as described above, part of the creating of the event includes identifying the direction of the auction (step 240). With all of the information for the event entered, the event is posted to the market maker 120 (step 250). The posting of the event means that the event information is submitted to one of the forward auction engine 122, the reverse auction engine 124 or both. An event is submitted when the event information is stored in a database or a table in the data store 126.

In response to the posting of the event, the auction is conducted (step 260). The auction starts at the start time indicated in the auction object. During the auction, the participants 130 can submit bids to the engine in which the event has been posted. The participants 130 designated by the event information may receive notification of the posted event to inform the participants 130 to submit a bid. This notification may be, for example, by e-mail or by providing an indication when a participant 130 logs onto the forward auction engine 122 or the reverse auction engine 124. The bid may comprise various information including proposed price, quantity, and delivery dates.

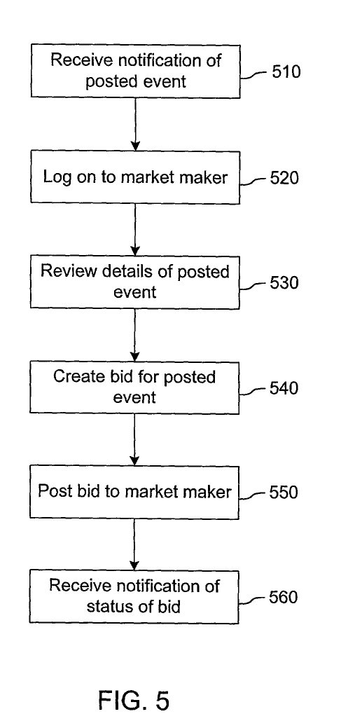

FIG. 5 is a flow diagram for creating a bid on the market maker 120 consistent with the present invention. This process is equally applicable to creating a bid on the forward auction engine 122 and the reverse auction engine 124. As shown in FIG. 5, a participant 130 receives notification of an event posted on the market maker 120 (step 510). This notification may be by e-mail. The participant 130 then logs on to the market maker 120 (step 520). The log on process may require the participant 130 to provide a username and password to access the market maker 120. If notified of the event by e-mail, the participant 130 may simply click on a URL in the e-mail to access the market maker 120.

After logging on to the market maker 120, the participant 130 may view a screen offering different options for the participant 130. Among these different options is an option to review the details of the posted event (step 530). To select this option, the participant 130 may click on a button on the view screen appearing after logging on or select the review option from a pull down menu. In addition to the event attributes, the participant 130 may download and view any attachments included in the event by the sponsor 110.

If the participant 130 wishes to respond to the event, the participant 130 may create a bid (step 540). The participant may elect to create a bid by clicking on a button on the view screen appearing with the reviewed event information or by selecting a create a bid option from a pull down menu. If the sponsor 110 has designated the structure and content of the bids to be submitted, the participant 130 may fill-in information in editable fields corresponding to the content requested by the sponsor 110, such as the timing or intervals over which the product will be delivered, the bid price, and how much of the product will be provided. The participant 130 may also enter additional information or comments about its bid, such as better prices available for increased amounts of the product. The bid information may be saved and updated at a later time before posting the bid to the market maker 120.

When the participant 130 has completed the bid, the bid may be posted to one of the forward auction engine 122 and the reverse auction engine 124 (step 550). The posting of the bid transfers the bid information from a temporary database, such as a scratch pad, to the data store 126 accessible to the auction engines. The information from each of the bids may be stored in cached memory areas of the data store 126, analogous to the caching of web page data. The cached memory areas may be implemented as Enterprise Java Beads (EJBs), a feature of Java, a product of Sun Microsystems. An EJB can hold data that is accessible to both the forward auction engine 122 and the reverse auction engine 124.

The sponsor 110 may then be notified of the bid (step 560). The sponsor 110 may be notified of the bid by e-mail or by an indication when the sponsor logs on to the market maker 120. However, if the sponsor 110 has designated a time when the auction ends, the sponsor can simply log on to the market maker 120 after that time and review whatever bids have been posted.

Again returning to FIG. 2, after all of the bids have been submitted for the auction posted by the sponsor 110, the auction is awarded to the winning bid (step 270). The sponsor 110 may choose to automatically award the winner of the auction once an auction has ended based on award criteria specified in the event. An auction-parameter object corresponding to the award criteria holds the award criteria specified by the sponsor 110 in the event and includes the functionality for evaluating the bids to determine the winner based on the specified award criteria. For example, the award criteria may specify the winner as the highest bidder for a forward auction or the lowest bidder for a reverse auction.

The results from the auction are then stored in the data store 126 (step 280). In particular, the information for the bid awarded as the winner of the auction may be stored in the cached memory areas of the data store 126, as described above, such as in an EJB. The information from the winning bid may include, for example, a description of what was bought, the price, how much was purchased, who purchased it, the name of the auction, any shipping terms, and any special terms, such as volume discounts.

At this point, the sponsor 110 can use the event information and the result information from the just completed auction to run the other of the forward or reverse auction (step 290). For example, if the sponsor 110 had just run a reverse auction, the sponsor 110 can use the same event information, such as the description of the item, the results of the reverse auction, such as the purchase or sale price, and merely change, for example, the auction-parameter objects corresponding to the direction of the auction and the award criteria.

Through the use of the single software component and the shared data store 126, the sponsor 110 can run both a reverse and a forward auction without having to reenter information or use a different software component. The ability to run both a forward auction and a reverse auction in a single system, the market maker 120, allows the sponsor 110 to make a profit through a spread in the price paid in the reverse auction versus the price received in the forward auction.

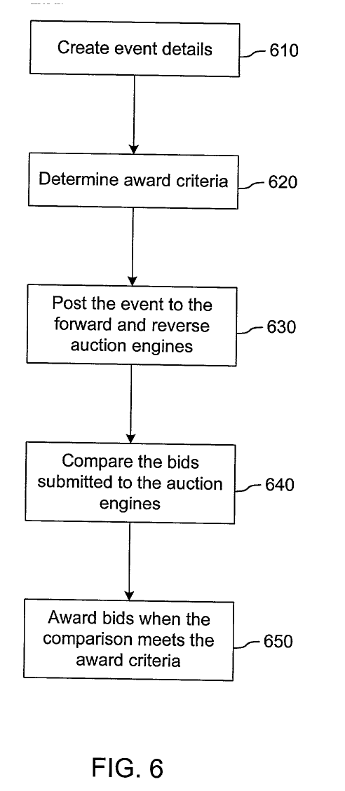

FIG. 6 is a flow diagram of a simultaneous forward and reverse auction process consistent with the present invention. As shown in FIG. 6, the sponsor 110 first creates the event details, as described above in FIG. 4 (step 610). Since the forward and reverse auctions are going to be run at the same time, the sponsor 110 would indicate that the direction of the auction is both, such that both the forward auction and the reverse auction are each run. In addition, the sponsor 110 may designate different participants 130 for the reverse auction and the forward auction. For example, the sponsor 110 may be a middleman between manufacturers of a product and retailers of the product. In this situation, the sponsor 110 would conduct a reverse auction for the manufacturers of the product and a forward auction for the retailers of the product. In another context, the sponsor could be the middleman between sellers and buyers of securities, such as stocks and bonds.

In addition to creating the event details, the sponsor 110 also specifies the award criteria (step 620). Unlike the situation where either a forward or reverse auction is run, and the award criteria typically awards the lowest or highest bid, the award criteria for the simultaneous running of the forward and reverse auctions is generally dependent on the relationship of the bids in the two auctions to each other. The award criteria may specify that the auctions run until a sufficient spread is met. For example, the auctions may run until a bid from the reverse auction is sufficiently lower than a bid from the forward auction. The differences between the bid in the reverse auction versus the bid in the forward auction corresponds to the spread.

With the details of the event along with the award criteria complete, the event is posted to the forward auction engine 122 and the reverse auction engine 124 (step 630). As described above, the posting of the event means that the event information is submitted to both the forward auction engine 122 and the reverse auction engine 124. An event is submitted when the event information is stored in a database or a table in the data store 126.

With the forward and reverse auctions running simultaneously, the bids received for each of the auctions are compared to each other (step 640). Each of the received bids may be stored in a cached memory area of the data store 126, such as in an EJB. The bids from the reverse auction may be compared to the bids of the forward auction, and the differences between them can be determined. For example, the bid of a seller of a particular stock in the reverse auction may be compared to the bid of a buyer of the particular stock in the forward auction. The functionality for doing the comparison may be included in the auction-parameter object corresponding to a simultaneous forward and reverse auction or part of the auction-parameter object corresponding to the award criteria.

Based on the comparison, a bid from the forward auction and a bid from the reverse auction are determined to be the winning bids according to the award criteria specified by the sponsor 110 (step 650). For example, once the difference between a bid received in the reverse auction and a bid received in the forward auction exceeds a threshold set in the award criteria, the auctions are stopped and those bids are determined to be the winning bids.

The foregoing description of a preferred embodiment of the invention has been presented for purposes of illustration and description. It is not intended to be exhaustive or to limit the invention to the precise form disclosed, and modifications and variations are possible in light in the above teachings or may be acquired from practice of the invention. The embodiment was chosen and described to explain the principles of the invention and as a practical application to enable one skilled in the art to utilize the invention in various embodiments and with various modifications suited to the particular use contemplated. It is intended that the scope of the invention be defined by the claims appended hereto and their equivalents.

1. A method for conducting a forward auction and a reverse auction from a single software component operable on a computer system, comprising:
receiving information regarding the details of the auction and the direction of the auction, where the direction is either forward or reverse;
running a first auction based on the received information with the single software component;
receiving at least one bid;
determining a winner of the first auction from the at least one bid; and
running a second auction with the single software component in the other of the forward or reverse direction based on the received information and information related to the determined winning bid.

2. A method according to claim 1, wherein the single software component is a self-contained re-deployable piece of software code.

3. A method according to claim 1, wherein the single software component comprises pre-developed pieces of application code assembled into a single working application system.

4. A method according to claim 1, wherein the step of receiving information includes:
receiving information corresponding to an auction object; and
receiving information corresponding to one or more auction-parameter objects.

5. A method according to claim 4, wherein the auction object includes the name of the auction and the start and end time of the auction.

6. A method according to claim 4, wherein the auction-parameter objects include at least one of the description of the item being sold or purchased, the amount of the item being sold or purchased, the direction of the auction and a target price.

7. A method according to claim 6, wherein the auction-parameter object corresponding to the direction of the auction includes functionality for performing the auction in the applicable direction.

8. A method according to claim 4, further comprising:
storing the auction object and the auction-parameter objects in a data store.

9. A method according to claim 8, further comprising:
providing a reference for the auction object to the auction-parameter objects.

10. A method according to claim 9, wherein the reference is a pointer from the auction object to the auction-parameter objects.

11. A method according to claim 1, further comprising:
sending notification to each of a first group of participants for the first auction to submit a bid; and
sending notification to each of a second group of participants for the second auction to submit a bid.

12. A method according to claim 11, wherein at least one participant in the first group of participants is different from at least one participant in the second group of participants.

13. A method according to claim 1, wherein the information relating to the determined winning bid includes the purchase or sale price, how much was purchased or sold, the identity of the buyer or seller, and the name of the auction.

14. A method according to claim 1, further comprising:
receiving at least one bid for the second auction; and
determining a winner for the second auction based on the at least one bid received for the second auction and the information relating to the determined winning bid of the first auction.

15. A method for conducting a forward auction and a reverse auction from a single software component operable on a computer system, comprising:
receiving information regarding the details of the forward and reverse auction;
running a first auction in a forward direction and a second auction in a reverse direction based on the received information with the single software component;
receiving at least one bid for each of the first and second auctions; and
determining a winner for the first and second auctions based on the at least one bid received for the first and second auctions and award criteria.

16. A method according to claim 15, wherein the first auction is for selling an item and the second auction is for purchasing the same item.

17. A method according to claim 16, wherein the award criteria includes a minimum difference in price for a bid received for the first auction and a bid received for the second auction.

18. A computer readable medium operable on a computer system for conducting a forward auction and a reverse auction with a single software component operable on the computer system, the computer readable medium configured to:
receive information regarding the details of the auction and the direction of the auction, where the direction is either forward or reverse;
run a first auction based on the received information with the single software component;
receive at least one bid;
determine a winner of the first auction from the at least one bid; and
run a second auction with the single software component in the other of the forward or reverse direction based on the received information and information related to the determined winning bid.

19. A computer readable medium according to claim 18, wherein the single software component is a self-contained re-deployable piece of software code.

20. A computer readable medium according to claim 18, wherein the single software component comprises pre-developed pieces of application code assembled into a single working application system.

21. A computer readable medium according to claim 18, further configured to:
receive information corresponding to an auction object; and
receive information corresponding to one or more auction-parameter objects.

22. A computer readable medium according to claim 21, wherein the auction object includes the name of the auction and the start and end time of the auction.

23. A computer readable medium according to claim 21, wherein the auction-parameter objects include at least one of the description of the item being sold or purchased, the amount of the item being sold or purchased, the direction of the auction and a target price.

24. A computer readable medium according to claim 23, wherein the auction-parameter object corresponding to the direction of the auction includes functionality for performing the auction in the applicable direction.

25. A computer readable medium according to claim 21, further configured to:
store the auction object and the auction-parameter objects in a data store.

26. A computer readable medium according to claim 25, further configured to:
provide a reference for the auction object to the auction-parameter objects.

27. A computer readable medium according to claim 26, wherein the reference is a pointer from the auction object to the auction-parameter objects.

28. A computer readable medium according to claim 18, further configured to:
send notification to each of a first group of participants for the first auction to submit a bid; and
send notification to each of a second group of participants for the second auction to submit a bid.

29. A computer readable medium according to claim 28, wherein at least one participant in the first group of participants is different from at least one participant in the second group of participants.

30. A computer readable medium according to claim 18, wherein the information relating to the determined winning bid includes the purchase or sale price, how much was purchased or sold, the identity of the buyer or seller, and the name of the auction.

31. A computer readable medium according to claim 18, further configured to:
receive at least one bid for the second auction; and
determine a winner for the second auction based on the at least one bid received for the second auction and the information relating to the determined winning bid of the first auction.

32. A computer readable medium operable on a computer system for conducting a forward auction and a reverse auction with a single software component operable on the computer system, the computer readable medium configured to:
receive information regarding the details of the forward and reverse auction;
run a first auction in a forward direction and a second auction in a reverse direction based on the received information with the single software component;
receive at least one bid for each of the first and second auctions; and
determine a winner for the first and second auctions based on the at least one bid received for the first and second auctions and award criteria.

33. A computer readable medium according to claim 15, wherein the first auction is for selling an item and the second auction is for purchasing the same item.

34. A computer readable medium according to claim 16, wherein the award criteria includes a minimum difference in price for a bid received for the first auction and a bid received for the second auction.

35. A computer system for conducting a forward auction and a reverse auction with a single software component operable on the computer system, comprising:
a processor; and
a memory coupled to the processor, the memory comprising a plurality of instructions executed by the process, the instructions configured to:
receive information regarding the details of the auction and the direction of the auction, where the direction is either forward or reverse;
run a first auction based on the received information with the single software component;
receive at least one bid;
determine a winner of the first auction from the at least one bid; and
run a second auction with the single software component in the other of the forward or reverse direction based on the received information and information related to the determined winning bid.

36. A computer system according to claim 35, wherein the single software component is a self-contained re-deployable piece of software code.

37. A computer system according to claim 35, wherein the single software component comprises pre-developed pieces of application code assembled into a single working application system.

38. A computer system according to claim 35, the instructions further configured to:
receive information corresponding to an auction object; and
receive information corresponding to one or more auction-parameter objects.

39. A computer system according to claim 38, wherein the auction object includes the name of the auction and the start and end time of the auction.

40. A computer system according to claim 38, wherein the auction-parameter objects include at least one of the description of the item being sold or purchased, the amount of the item being sold or purchased, the direction of the auction and a target price.

41. A computer system according to claim 40, wherein the auction-parameter object corresponding to the direction of the auction includes functionality for performing the auction in the applicable direction.

42. A computer system according to claim 40, the instructions further configured to:
store the auction object and the auction-parameter objects in a data store.

43. A computer system according to claim 42, the instructions further configured to:
provide a reference for the auction object to the auction-parameter objects.

44. A computer system according to claim 43, wherein the reference is a pointer from the auction object to the auction-parameter objects.

45. A computer system according to claim 35, the instructions further configured to:
send notification to each of a first group of participants for the first auction to submit a bid; and
send notification to each of a second group of participants for the second auction to submit a bid.

46. A computer system according to claim 45, wherein at least one participant in the first group of participants is different from at least one participant in the second group of participants.

47. A computer system according to claim 35, wherein the information relating to the determined winning bid includes the purchase or sale price, how much was purchased or sold, the identity of the buyer or seller, and the name of the auction.

48. A computer system according to claim 35, the instructions further configured to:
receive at least one bid for the second auction; and
determine a winner for the second auction based on the at least one bid received for the second auction and the information relating to the determined winning bid of the first auction.

49. A computer system for conducting a forward auction and a reverse auction with a single software component, comprising:
a processor; and
a memory coupled to the processor, the memory comprising a plurality of instructions executed by the process, the instructions configured to:
receive information regarding the details of the forward and reverse auction;
run a first auction in a forward direction and a second auction in a reverse direction based on the received information with the single software component; receive at least one bid for each of the first and second auctions; and determine a winner for the first and second auctions based on the at least one bid received for the first and second auctions and award criteria.

50. A computer system according to claim 15, wherein the first auction is for selling an item and the second auction is for purchasing the same item.

51. A computer system according to claim 16, wherein the award criteria includes a minimum difference in price for a bid received for the first auction and a bid received for the second auction.
